(19) United States
(12) Patent Application Publication
(10) Pub. No.: US 2004/0240533 A1
(43) Pub. Date: Dec. 2, 2004

(54) Cdma reception device, mobile communication terminal device, and base station device

(76) Inventors: Keiichi Kitagawa, Kanagawa (JP); Hidenori Kayama, Kanagawa (JP)

Correspondence Address: STEVENS DAVIS MILLER & MOSHER, LLP, 1615 L STREET, NW, SUITE 850, WASHINGTON, DC, 20036, US

(21) Appl. No.: 10/488,516

(22) PCT Filed: May 21, 2003
(86) PCT No.: PCT/JP03/06312

(30) Foreign Application Priority Data
May 22, 2002 (JP) 2002-148270

(51) Int. Cl. H04B 1/707

(52) U.S. Cl. 375/150

(57) ABSTRACT

A sliding correlation between a received signal and a basic midamble is detected, and a delay profile is generated from a correlation value as a detection result of the sliding correlation, and thereafter averaging processing of the delay profiles is executed. Moreover, the path position of the received signal is detected from the averaged delay profile. In a CDMA communication system where the phase shift amount of a common midamble included in a transmitting signal changes according to the number of codes multiplexed, averaging processing with correlation value output from a correlator is surely executed either before or after correlation detection processing using the common midamble in order to improve the accuracy of path position estimation before the common midamble is identified.

### TECHNICAL FIELD

The present invention relates to a CDMA receiving apparatus, a mobile communication terminal apparatus and a base station apparatus.

### BACKGROUND ART

A midamble code is used for channel estimation in a TD-SCDMA system, which-is a standard of a next-generation cellular phone adopted in China, or a TD-CDMA system (collectively referred to as CDMA-TDD system)

The midamble code (hereinafter referred to as midamble) is prepared by cyclically shifting one basic midamble code (hereinafter referred to as basic midamble) as illustrated in FIG. 1A.

The basic midamble length of TD-SCDMA is 128 chips. When, for example, four midambles are generated from the basic midamble, those that are shifted by w=32 chips are used as midambles m(1), m(2), m(3) and m(4).

In the TD-SCDMA system and TD-CDMA system, a sliding correlation between the midamble included in a received signal and the basic midamble (referring to continuously shifting the phase of a basic midamble used as the basis of midamble preparation from the initial phase and obtaining correlation values) is detected based on this cyclic configuration, thereby making it possible to generate delay profiles corresponding to the respective midambles (m(1) to m(4)) at the same time.

For example, FIG. 1B is a view illustrating a correlation output obtained when only a signal sequence including midamble m(3) is transmitted. Regarding the midambles m(1), m(2) and m(4), a delay profile also appears as a correlation output in each corresponding segment when transmission is performed.

Accordingly, in the TD-SCDMA system and TD-CDMA system, with regards to the other station wherein midambles different from those of self-station are allocated together with delay profiles of the self-station, delayprofiles can be generated at the same time using a common correlator, and they can be used in joint detection demodulation and the like.

Here, the midambles in the downlink (forward link) can be largely divided into individual midambles and common midambles.

The individual midambles are used in a system in which the midambles each having a different pattern for each spreading code are allocated. moreover, the common midambles are used in a system in which the same (common) midamble is allocated to all communication terminals under a predetermined condition (for example, the communication terminals are installed in the same room).

In the case where an individual midamble is used, since the individual midamble is known to both the base station and the mobile communication terminal apparatus and always corresponds to one spreading code, it is easy for the mobile communication terminal apparatus to receive a signal and execute channel estimation (link estimation).

Although the common midambles are used in the system in which the same (common) midamble is allocated to all mobile communication terminal apparatuses, the number of types of the common midambles is not fixed to one. For example, in the TD-SCDMA system and TD-CDMA system which comply to TS25.221, the common midamble used by the base station (transmitting side) is decided according to the number of multiplex codes upon transmission (namely, upon common midamble allocation). FIG. 2 shows one example of a corresponding relationship between the number of multiplex codes and the number of midamble shifts. Accordingly, if the number of multiplex codes changes, a pattern of the common midamble, which is to be inserted into a transmitting signal, also changes.

FIG. 1C is a view illustrating a correlation output when the number of allocating codes changes with time and the common midamble to be used changes accordingly.

Since the midamble is generated by shifting the basic midamble as explained above, a segment where a correlation value can be obtained (timing a segment where a correlation value can be obtained appears) shifts when the sliding correlation is obtained according to the amount of shift.

A communication terminal (receiving side) detects to what degree a phase (timing) shifts with reference to a top position of the basic midamble when the delay profile is obtained as in FIG. 1C, thereby specifying which common midamble is used (identifying the common midamble).

In this way, even when the common midamble is used, it is possible to generate the delay profile and identify the common midamble.

When the delay profile is obtained, a position of a path available for demodulation processing (rake combining and the like) can be obtained based on the delay profile.

In the system that decides the common midamble for use according to the number of the multiplex modes upon transmission, the pattern of the common midamble included in a received signal is unclear at the stage before identifying the common midamble in receiver-side equipment as mentioned above, the phase of the basic midamble is continuously shifted from the initial phase to specify the segment where a correlation value appears and to generate a delay profile (generate a delay profile by the sliding correlation), thereby enabling to detect the position of the path available for identification of the common midamble and demodulation.

The path position is detected based on not the outputs themselves of the correlator (matched filter and the like) but one (average delay profile) that is obtained by time averaging them and this is desirable in view of the point that noise is suppressed to prevent erroneous detection.

In the detection of the path position using the common midamble, since the time period for which a sliding correlation is long and the correlation value appears in only a certain segment in order to use averaging processing as mentioned above, averaging processing must be executed in only the segment (if the other segment is also time integrated, a noise component mixed in the other segment also becomes subject to averaging, so that accuracy in the delay profile decreases).

However, since it is unclear in which segment the correlation value appears, it is difficult to provide averaging processing to only the segment where the correlation value appears in the prior art.

In other words, since it is known in which segment the correlation value appears after the common midamble is identified, averaging processing can be easily executed in generating the delay profile. However, since it is unclear in which segment the correlation value appears before the common midamble is identified, and averaging processing cannot be executed at this stage.

When the path position is detected using the delay profile based on only instantaneous data without executing averaging processing for suppressing noise, there is a danger that timing, which is not an original path position, will be erroneously detected as a correct path position because of an influence of noise and the like.

Particularly, in a case where communication is performed under adverse conditions, a danger that the path position cannot be correctly detected is increased unless averaging processing for suppressing noise is executed in delay profile generation processing.

### DISCLOSURE OF INVENTION

The present invention has been made in consideration of the aforementioned point and an object of the present invention is to improve estimation accuracy in a path position in common midamble allocation.

According to the present invention, in a CDMA communication system where a phase shift amount of common midamble included in a transmitting signal changes according to the number of codes to be multiplexed, averaging processing is surely executed to a correlation value output from a correlator either before or after correlation detection processing using the common midamble in order to improve accuracy in estimation of a path position at a stage where the common midamble has not been identified yet.

Namely, the CDMA receiving apparatus according to the present invention adopts either a method in which a window interval where averaging processing is executed is dynamically moved (this is a post method performed after correlation detection processing using the common midamble) or a method in which a series of processing up to the detection of the path position is largely divided into two stages including preliminary correlation detection processing using a fixed known code and correlation detection processing on the common midamble and averaging processing is executed to the delay profile at the stage of the preliminary correlation detection (namely, the stage before correlation detection processing is performed using the common midamble) (this is a prior method).

According to one aspect of the present invention, information on a shift amount is obtained from a delay profile obtained as a result of a correlation detection about a common midamble, the information on the phase shift amount is supplied to the averaging section, and averaging processing is executed to only a window interval where averaging processing should be executed (this is the post method that in which a window interval where averaging processing is executed is dynamically moved).

Namely, according to one aspect of the present invention, a CDMA receiving apparatus comprises a midamble correlation section that detects a sliding correlation between a received signal and a basic midamble, a delay profile generating section that generates a delay profile from a correlation value as a detection result of the sliding correlation, an averaging section that averages the delay profile, and a path detecting section that detect a path position of the received signal from the averaged delay profile.

According to another aspect of the present invention, in place of the direct detection of the sliding correlation of the common midamble, correlation detection is first executed using a fixed known code (a code in which the contents periodically inserted into the received signal are fixed. A beacon channel is an example.) and a position where the common midamble will exist is indirectly estimated from the correlation detection result. Then, averaging processing is executed to the delay profile based on the correlation detection at this state. Since the correlation detection processing using the fixed known code eliminates the need for performing the sliding correlation unlike the correlation detection processing on the common midamble, there is no difficulty in executing averaging processing. Next, correlation detection on the common midamble is executed to specify a path position using a simply configured correlator (namely, having a configuration wherein a plurality of correlators corresponding to the respective window intervals is provided and each correlator performs correlation detection at timing designated by an external section) based on the aforementioned estimation (this is the prior method that executes averaging processing to the delay profiles at the stage of the preliminary correlation detection).

In other words, according to another aspect of the present invention, a CDMA receiving apparatus comprises a midamble correlation section that detects a sliding correlation between a received signal of a midamble segment of a beacon channel and a basic midamble, a delay profile generating section that generates a delay profile from a correlation value as a detection result of the sliding correlation, an averaging section that averages the delay profile, a path detecting section that detects a path position of the beacon channel from the averaged delay profile, a correlation section that performs correlation operation with a received signal of a time slot of a path as a detecting object at timing of the detected path position, a determination value calculating section that calculates a determination value from the correlation value output obtained by the correlation operation, a midamble shift detecting section that detects a midamble shift amount from the determination value, a selector that selects the correlation value output according to the midamble shift amount, and a path determining section that determines a path position of the received signal from the correlation value output selected by the selector.

Moreover, according to another aspect of the present invention, the CDMA receiving apparatus of the invention uses SYNC-DL, which is an initial synchronization code, in place of the midamble field of the beacon channel.

Moreover, according to another aspect of the present invention, in the CDMA receiving apparatus of the invention, the correlation section performs correlation operation with the received signal of time slots before and after the timing.

Furthermore, according to another aspect of the present invention, in the CDMA receiving apparatus of the invention, the determination value calculated by the determination value calculating section is one that is obtained by combining correlation values of paths of the respective midamble shifts.

Furthermore, according to another aspect of the present invention, in the CDMA receiving apparatus of the invention, the determination value calculated by the determination value calculating section is a maximum value of correlation values of paths of the respective midamble shifts.

Moreover, according to another aspect of the present invention, a mobile communication terminal apparatus has the CDMA receiving apparatus described in claim 1.

Moreover, according to another aspect of the present invention, a base station apparatus has the CDMA receiving apparatus described in claim 1.

### BRIEF DESCRIPTION OF DRAWINGS

FIG. 1A is a view illustrating a common midamble generating method;

FIG. 1B is a view illustrating one example of a delay profile obtained as a detection result of a sliding correlation between a common midamble included in a received signal and a basic midamble;

FIG. 1C is a view illustrating a state in which a window interval where a correlation value is obtained with a change in the number of codes of a received signal changes, and a state in which a window interval where averaging processing is performed is moved adaptively according to the change;

FIG. 2 is a view illustrating one example of a relationship between the number of multiplexed codes and a common midamble shift;

FIG. 3A is a block diagram of a CDMA receiving apparatus for explaining the outline of one embodiment of the present invention (apparatus that moves a window interval where averaging processing is performed based on a delay profile obtained by detection of a sliding correlation relating to a common midamble);

FIG. 3B is a block diagram of a CDMA receiving apparatus for explaining the outline of another embodiment of the present invention (apparatus that performs averaging processing at a stage of a correction detection processing using a fixed known code);

FIG. 4 is a view illustrating a configuration example of a frame format in a TD-SCDMA system and one time slot;

FIG. 5 is a block diagram illustrating a configuration of a communication terminal (mobile communication terminal apparatus) according to Embodiment 1 of the present invention;

FIG. 6 is a block diagram illustrating a configuration of a communication terminal (mobile communication terminal apparatus) according to Embodiment 2 of the present invention;

FIG. 7A is a block diagram illustrating a configuration of a correlator section in a receiving apparatus according to Embodiment 3 of the present invention;

FIG. 7B is a view illustrating an example of a correlation value output before a variation in path position occurs; and

FIG. 7C is a view illustrating an example of a correlation value output after a variation in path position occurs.

### BEST MODE FOR CARRYING OUT THE INVENTION

The outlines of two basic embodiments of the present invention will be explained with reference to the accompanying drawings.

The feature of the present invention lies in the point that averaging processing is surely executed to a correlation value output from a correlator in order to improve accuracy in estimation of a path position at a stage before a common midamble is identified.

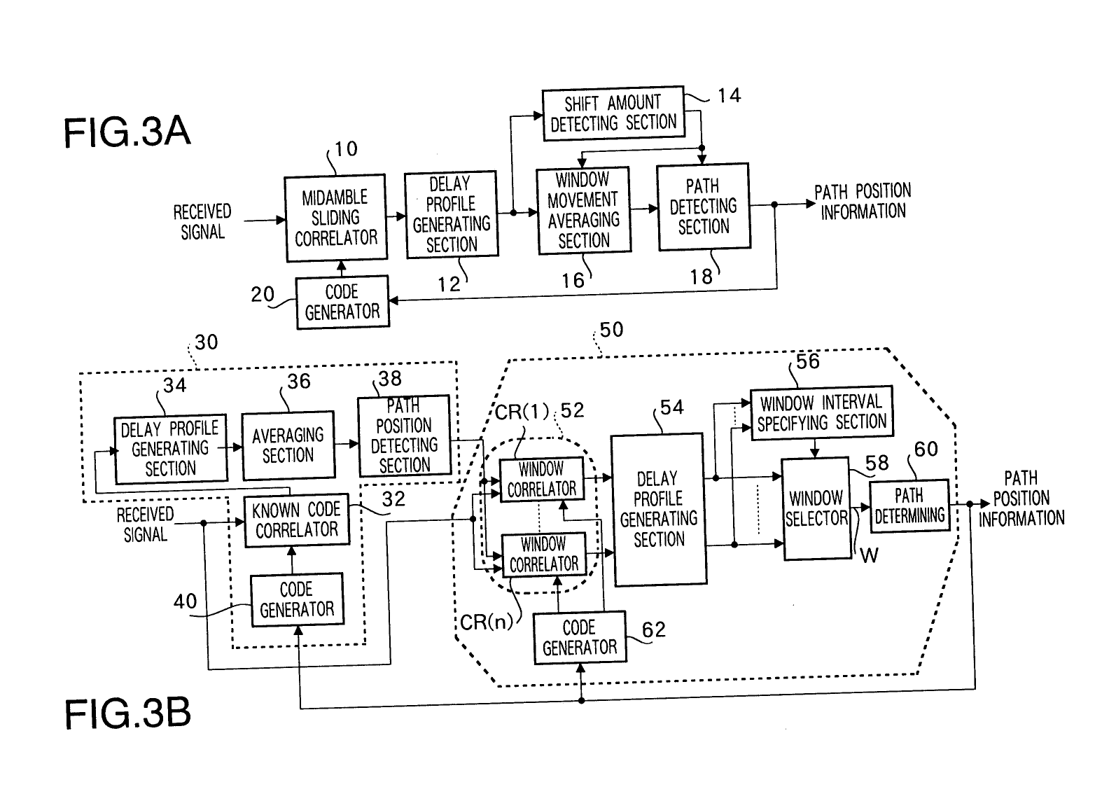

In order to implement this, a CDMA receiving apparatus illustrated in FIG. 3A adopts a method for dynamically moving a window interval where averaging processing is executed.

A received signal (received signal subjected to A/D conversion) including a common midamble field and a data field is input to a midamble sliding correlator 10 in the CDMA receiving apparatus of FIG. 3A to detect a sliding correlation between a common midamble and a basic midamble included in the received signal.

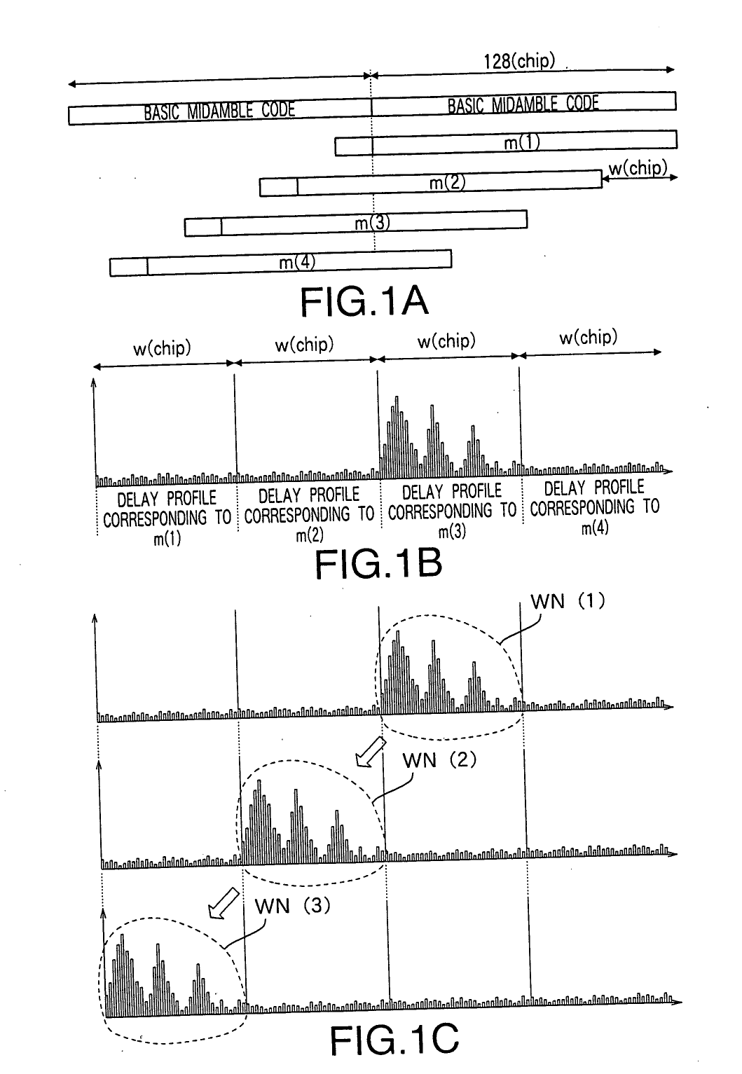

As illustrated in FIG. 1A, the common midamble is generated by shifting a phase of the basic midamble using a predetermined amount (w chip) as a basic unit, and the shift amount dynamically changes according to the number of multiplexes of multicodes. As a result of the sliding correlation detection, correlation values described in, for example, FIG. 1B, are output. When the number of multicodes changes continuously, a segment where the correlation value is obtained (a segment having a length corresponding to a shift amount of the common midamble, and this segment is used as a range where averaging processing is executed and referred to as window interval) changes one after another as illustrated in, for example, FIG. 1C.

Next, a delay profile generating section 12 calculates reception power using the correlation values output from the midamble sliding corrector 10 to generate a delay profile.

Since there is a possibility that an instantaneous noise component will be mixed in this delay profile, a window movement averaging section 16 executes time averaging processing (time integration processing) for noise suppression.

However, since it is unclear in which window interval the correlation value appears, a shift amount detecting section 14 detects a shift amount of the common midamble based on the delay profile. Then, information of the shift amount is sent to a path detecting section 18 and the window movement averaging section 16.

The window movement averaging section 16 moves the window interval where averaging processing is executed from WN (1) to WN (3) sequentially based on the information of the shift amount as illustrated in, for example, FIG. 1C, and executes averaging processing of the delay profile.

The path detecting section 18 detects a position of a path available for demodulation and outputs information indicating the position of the path (path position information) based on the averaging delay profile thus obtained. Additionally, the path position information is fed back to a code generator 20.

In such an embodiment, since the window interval where averaging processing is executed according to the shift amount of the common midamble is changed, so that averaging processing is executed without fail, noise is canceled to suppress a noise level.

The processing steps in this embodiment are summarized as follows.

Namely, in connection with the common midamble code, a correlation is detected over a wide range that covers an estimated whole phase shift range (common midamble sliding correction detection) to generate a delay profile, and midamble shift amount information is obtained based on the delay profile.

Next, an averaging processing segment (window where averaging processing is executed) to a common midamble sliding correlation detection output (delay profile) is decided based on the common midamble shift amount information, and averaging processing is executed to only the segment (window) (namely, a window for averaging is adaptively moved to perform averaging processing) to obtain an averaged delay profile.

After that, it is possible to obtain information (path position information) relating to the position of a path available for rake combining reception based on the averaged delay profile.

An explanation will be next given of the CDMA receiving apparatus illustrated in FIG. 3B.

The CDMA receiving apparatus illustrated in FIG. 3B adopts a method that divides correlation detection processing into two stages to execute averaging processing to the delay profile at the stage of a preliminary detection using a known fixed code.

The CDMA receiving apparatus illustrated in FIG. 3B has a first correlation detecting section 30 that performs the preliminary correlation detection using the known fixed code (beacon channel and the like) and a second correlation detecting section 50 that performs a correlation detection using the common midamble.

The first correlation detecting section 30 includes a known code correlator 32, a delay profile generating section 34, an averaging section 36, a path position detecting section 38, and a code generator 40.

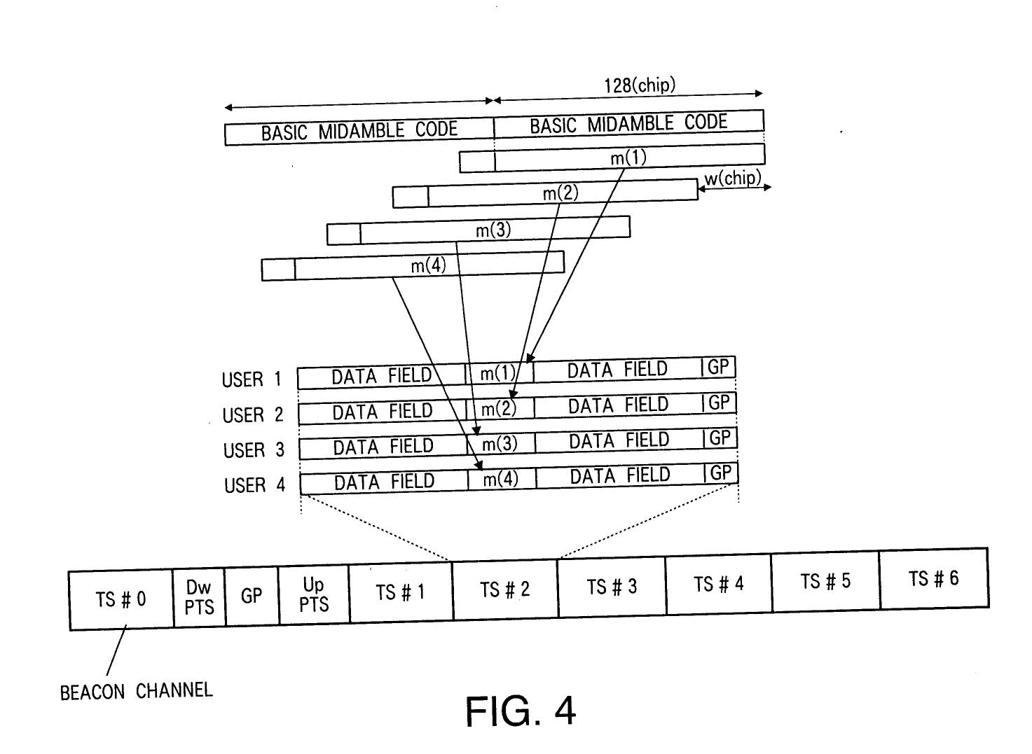

FIG. 4 is a view illustrating a frame format of a TD-SCDMA system. In the TD-SCDMA system, a channel, in which a midamble shift called a beacon channel is fixed, is inserted into a time slot 0 (TS#0). Since the contents are fixed, when the correlation detection is executed using the midamble of the beacon channel, the correlation value is periodically obtained. Accordingly, regarding time slot 0, averaging processing is executed by a general method without moving the window interval.

The CDMA receiving apparatus of FIG. 3B pays attention to this point to generate a delay profile subjected to averaging processing before correlation processing using the common midamble, and removes a danger of an erroneous detection caused by noise at this stage.

A second correlator 50 includes a window correlation section 52 (having window correlators CR (1) to CR (n) corresponding to the window intervals shown in FIG. 1C, respectively), a delay profile generating section 54, a window interval specifying section 56, a window selector 58, a path determining section 60, and a code generator 62.

Path position information detected by the path position detecting section 38 of the first correlation detecting section 30 is given to each of the correlators CR (1) to CR (n) of the window correlation section 52.

As illustrated in FIG. 4, since a relative positional relationship between the beacon channel and the position of the other downlink time slot (specifically, an inserting position of the common midamble included in the time slot) is known, given that the position of the beacon channel (appearing timing) is recognized, it is possible to estimate the position of the common midamble (appearing timing) with reference to this.

The respective window correlators CR (1) to CR (n) execute correlation detection at timing at which the common midamble is estimated to appear based on the path position information given from the path position detecting section 38.

The delay profile generating section 54 executes power calculation on a received signal to generate a delay profile based on the outputs of the respective window correlators CR (1) to CR (n).

The window interval specifying section 56 specifies in which window interval the correlation value appears (FIG. 1) to provide information on the specified window to the window selector 58.

The window selector 58 selects and outputs only a correlation value in the specified window interval. The correlation value output at this time is shown by the mark “W” in FIG. 3B.

The path determining section 60 selects a path, which exceeds a predetermined threshold value, from among correlation values W, and outputs path position information. The path position information is fed back to the code generators 40 and 62 and used in demodulation processing.

The CDMA receiving apparatus of FIG. 3B does not execute averaging processing in the correction detection relating to the common midamble, but executes processing for specifying a position of the known code at the previous stage, and, based on the specified position, estimates a position where the common midamble is likely to appear (timing at which the common midamble is likely to appear). Then, since averaging processing has been executed in the processing for specifying the position of the known code, a danger of an erroneous detection caused by noise in this processing is greatly reduced. Then, timing at which the common midamble code is likely to appear is estimated based on the position of the specified known code (having high reliability since averaging processing has been performed thereto), and a plurality of correlators corresponding to the respective midamble shifts are simultaneously operated in parallel at this timing to execute correlation processing. As a result, (what is estimated to be) a correlation output is output from any one of the correlators. Since the output appears at timing at which the common midamble is likely to appear, there is a greatly high possibility that the output will not be noise but a normal correlation output. Accordingly, it is considered that there is little problem even if this is directly adopted without executing averaging processing. In this way, the CDMA receiving apparatus of FIG. 3B can resultantly improve estimation accuracy in the path position at the common midamble allocating time, similar to the CDMA receiving apparatus of FIG. 3A.

The aforementioned processing steps can be summarized as follows.

Namely, in connection with the known code (code whose pattern is fixed), correlation is detected, averaging processing is executed, and a peak position (path position) is detected from the averaged delay profile, and a position (timing) where a common midamble code is likely to appear is estimated based on this.

Next, information on the aforementioned estimated timing is provided to the plurality of correlators provided to be associated with each shift amount of the common midamble code, and each window correlator is caused to execute correlation detection processing to generate a delay profile. Then, peak determination processing is executed based on the delay profile to determine a window interval where a correlation value appears, and only a correlation value in the window interval is selected and extracted to execute path determination processing to obtain information on a path position available for rake combing.

Embodiments of the present invention will be more specifically explained with reference to, the drawings.

(Embodiment 1)

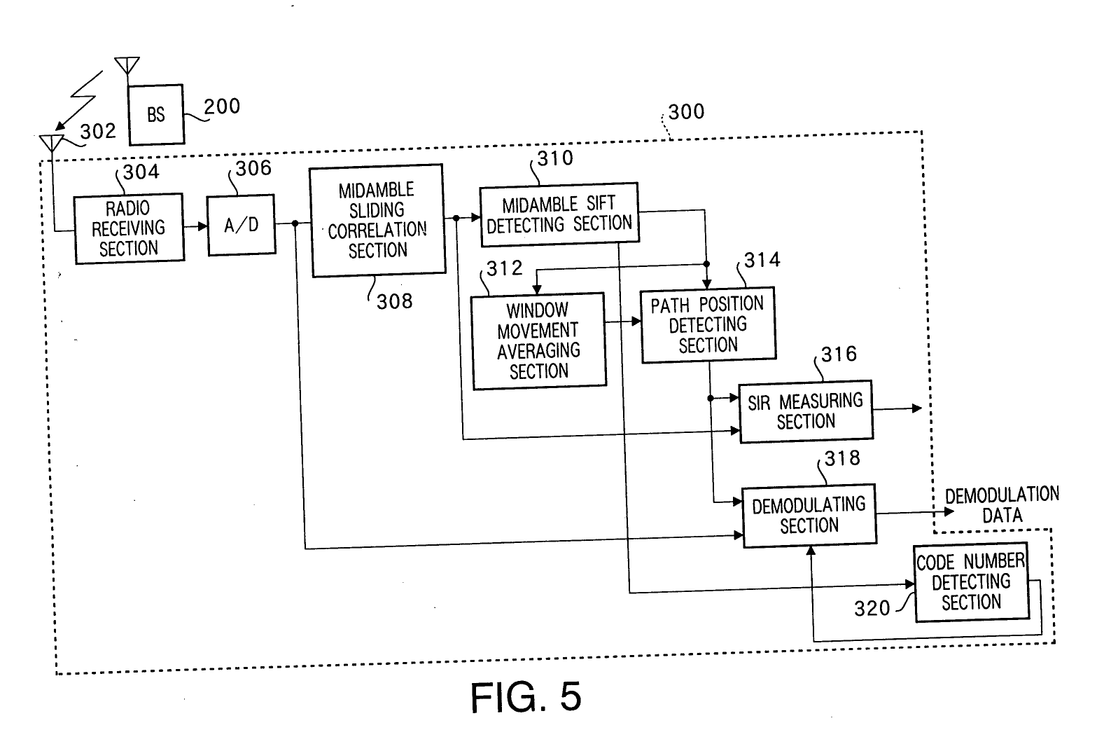

FIG. 5 is a block diagram illustrating a configuration of a mobile communication terminal apparatus according to Embodiment 1 of the present invention.

A mobile communication terminal apparatus 300 illustrated in FIG. 5 executes path detection using the method explained by use of FIG. 3A, and the main configuration section and operation are the same as the CDMA receiving apparatus of FIG. 3A.

The mobile communication terminal apparatus 300 is a cellular phone or an equivalent that receives a transmitting signal (downlink signal) of CDMA-TDD system from a base station (BS) 200.

The mobile communication terminal apparatus 300 includes a radio receiving section 304, an A/D converter 306, a midamble sliding correlation section 308, amidamble shift detecting section 310, a window movement averaging section 312, a path position detecting section 314, an SIR measuring section 316, a demodulating section 318, and a code number detecting section 320.

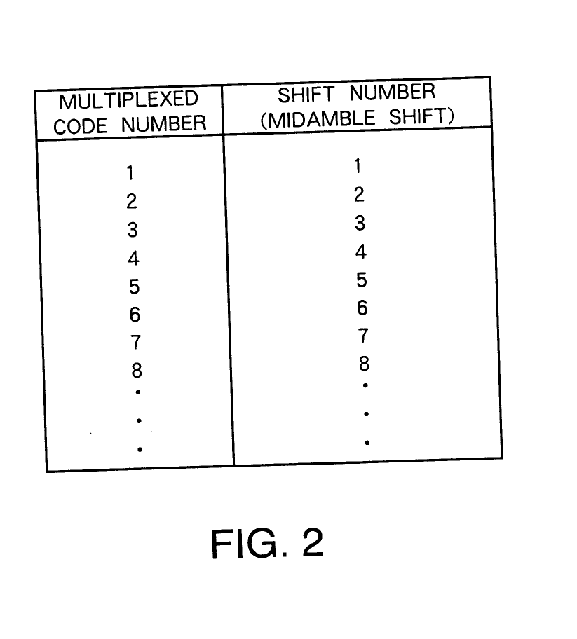

The code number detecting section 320 has a table showing a correspondence between the number of multiplexed codes and midamble shifts (the number of shifts) as illustrated in FIG. 2. Then, the number of codes multiplexed into a received signal with reference to the table of FIG. 2 is determined based on a signal indicating a detection result of the midamble shift detecting section 310. Information on the determined number of codes is used in demodulation processing in the demodulating section 318.

The window movement averaging section 312 decides a segment where averaging processing is executed to the delay profiles that are correlation outputs from the midamble sliding correlation section 308 according to information on the midamble shift amount from the midamble shift detecting section 310, executes averaging processing in only the decided segment, and outputs an obtained averaged delay profile to the path position detecting section 314.

The path position detecting section 314 detects a path position based on the averaged delay profile.

Delay profile information from the midamble sliding correlation section 308 is input to the SIR measuring section 316, and path position information is input from the path position detecting section 314. The SIR measuring section 316 executes SIR measurement based on these input information.

Moreover, the demodulating section 318 executes demodulation processing using the path position detecting section 314.

According to the receiving apparatus of this embodiment, the averaged delay profile is used, so that path position estimation accuracy improves, and also the measuring performance of SIR measurement using the path position information and demodulation performance improve.

FIG. 4 is a view illustrating a configuration example of a format of the entire frame of TD-SCDMA system and one time slot (TS) included in the frame. The format of the entire frame of TD-SCDMA system is shown at the lowest field in FIG. 4.

An object to be subjected to path position detection is allocated time slots including time slot 2 (TS#2) to time slot 6 (TS#6).

Each time slot (format of TS#2 is extracted and shown in FIG. 4, but the same applies to other time slots) includes two data fields, a midamble with 144 chips, and a guard period (GP). Regarding the way to insert the midamble, in a case where, for example, a user 1 uses m(1) and a user 2 uses m(2) (the same applies to the following), each midamble generated by the method of FIG. 1A is embedded in one time slot in such a form to be interposed between two data fields as illustrated in the figure.

The delay profile can be obtained by detecting the sliding correlation between 128 chips (top 16 chips of 144 chips are removed from 144 chips) of the midamble section of the received signal and the basic midamble. As mentioned above, the midamble section is inserted at the position interposed between two data fields in one time slot.

An operation of the averaging processing of the mobile communication terminal apparatus 300 will be next specifically explained using FIGS. 1B and 1C.

In the midamble sliding correlation section 308, a delay profile of the n-1th subframe is generated. The midamble shift detecting section 310 detects a shift amount corresponding to common midamble m(3), and sends information on the midamble shift amount to the window movement averaging section 312.

Of the delay profiles of correlation output, the window movement averaging section 312 sets averaging processing segment WN (1) to correspond to a window interval of m(3), so that averaging processing is executed in only this segment.

Next, a delay profile of n-th subframe is generated, averaging processing segment WN (2) is set in a window interval of m(2) in the same manner, so that averaging processing is executed in only this segment. Similar processings are executed afterward.

In this way, in the common midamble allocation, the averaging segment is moved according to the midamble shift to make it to follow adaptively, thereby enabling averaging of the delay profiles, and this suppresses noise to prevent detection of an erroneous path, which is not the original path, and improves the accuracy of path detection.

Moreover, in a case where the path position is detected by the path position detecting section 314, since it is necessary to inform in which segment a correlation value appears, there is need to originally inform the path position detecting section 314 of shift amount information from the midamble shift detecting section 310. Accordingly, in the present invention, shift amount information may be used to provide to the window movement averaging section 312, so that the implementation is simple.

Moreover, regarding the averaging processing by the window movement averaging section 312, since the shift amount of each window interval is known (it is known that the shift amount of common midamble is used in unit of chip), after timing at which averaging processing starts is decided based on the aforementioned shift amount information, averaging processing may be executed within the time length of one window interval, so that adaptive movement of window interval can be easily implemented.

In addition, it is obvious that a person skilled in the field of the communication technique could have configured the base station apparatus based on the mobile communication terminal apparatus 300 described in the present embodiment.

(Embodiment 2)

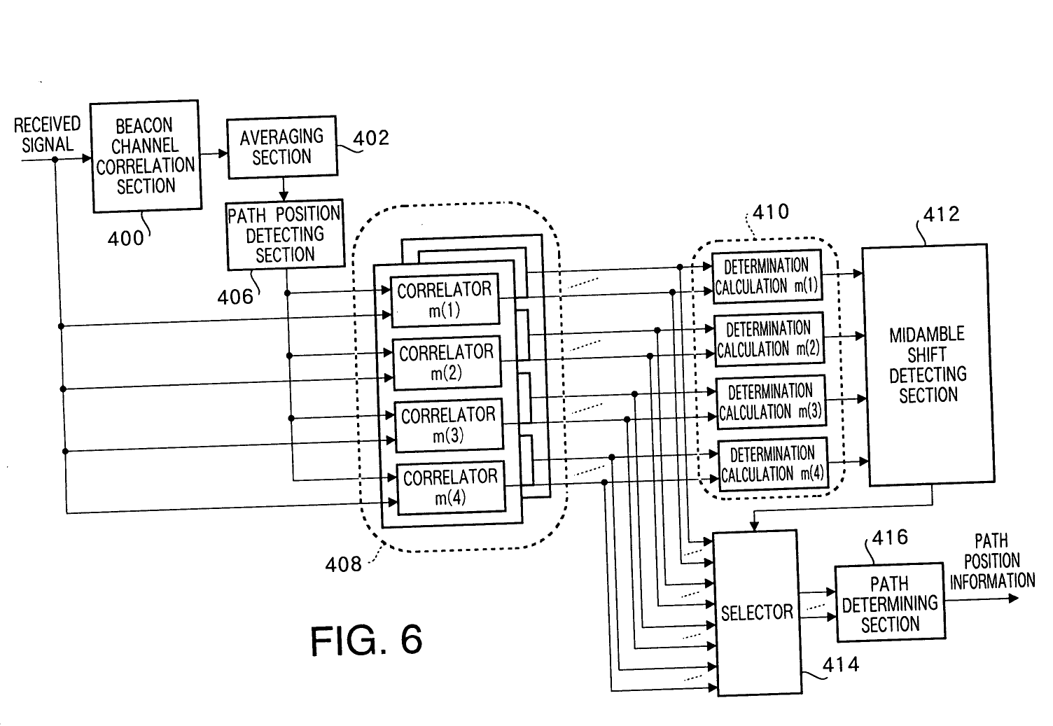

FIG. 6 is a block diagram illustrating a configuration of the CDMA receiving apparatus of Embodiment 2 of the present invention.

The CDMA receiving apparatus of FIG. 6 detects a path using the system explained with reference to FIG. 3B, and the main operation is the same as that of the CDMA receiving apparatus illustrated in FIG. 3B.

The CDMA receiving apparatus of FIG. 6 includes a beacon channel correlation section (beacon channel midamble correlation section) 400, an averaging section 402, a path position detecting section 406, a common midamble correlation section 408, a determination value calculating section 410, a midamble shift detecting section 412, a selector 414, and a path determining section 416.

In the frame of TD-SCDMA system, a channel, in which a midamble shift called beacon channel is fixed, is multiplexed into time slot 0 as described at the lowest portion of FIG. 4. Accordingly, regarding time slot 0, averaging processing is executed without moving the window interval.

Here, an object to be subjected to path position detection in this embodiment is time slot 2 to time slot 6 excepting for time slot 0 and time slot 1 allocated to the uplink.

The beacon channel correlation section 400 executes sliding correlation operation between a received signal segment, which corresponds to the midamble of the beacon channel where the midamble shift is known (namely, the pattern is fixed), and the basic midamble to generate a delay profile (no delay profile generating section is illustrated in FIG. 6).

The averaging section 402 averages the delay profiles. Here, regarding the beacon channel, since the midamble shift is fixed, averaging processing can be executed without moving the window interval.

Next, the path position detecting section 406 detects the path position with the beacon channel based on the averaged delay profile.

The common midamble correlation section 408 executes correlation operation between the received signal in the time slot segment as a path position detecting object and the midamble (for example, midambles m(1) to m(4) shown in FIG. 1A) to be used at timing in which the path position timing detected at the beacon channel is calculated as a reference.

Here, since the correlators, which form the common midamble correlation section 408 and which correspond to midambles m(1) to m(4) respectively, are configured by a simple integrator, the amount of processing is smaller than the sliding correlation.

A correlation output from each correlator is input to the determination value calculating section 410 for each midamble shift. The determination value calculating section 410 calculates a determination value.

Here, as a method for calculating the determination value, the maximum value of the same midamble shift is used or one that is obtained by path combining of the same midamble shift can be considered. The determination value calculated by the determination value calculating section 410 is output to the midamble shift detecting section 412 to detect a midamble shift amount.

The detected midamble shift amount is sent to the selector 414.

The selector 414 provides a correlation value in the window interval corresponding to the selected midamble shift to the path determining section 416.

The path determining section 416 selects only a path exceeding a predetermined value, and outputs information on the position of the path.

In this way, according to the receiving apparatus of the present embodiment, first of all, the midamble shift averages the delay profiles using the known beacon midamble, and thereafter the path position is detected. Next, a simple correlation operation is executed to the received signal of the time slot to be used as a path position to reduce the amount of processing, and thereafter making it possible to detect the path position.

Additionally, in the TD-SCDMA system, the path position may be detected by use of a synchronization code, which is called SYNC-DL used to obtain an initial synchronization in place of the midamble of the beacon channel. Here, SYNC-DL is a synchronization code for an initial synchronization used for downlink communications in the CDMA-TDD system.

In the present embodiment, though averaging processing is not performed in the correlation detection regarding the common midamble, the position where the common midamble is likely to exist is estimated at the previous stage and averaging processing is executed in this estimation, so that a danger of an erroneous detection caused by noise is greatly reduced. As a result, it is possible to improve estimation accuracy in the path position upon common midamble allocating.

(Embodiment 3)

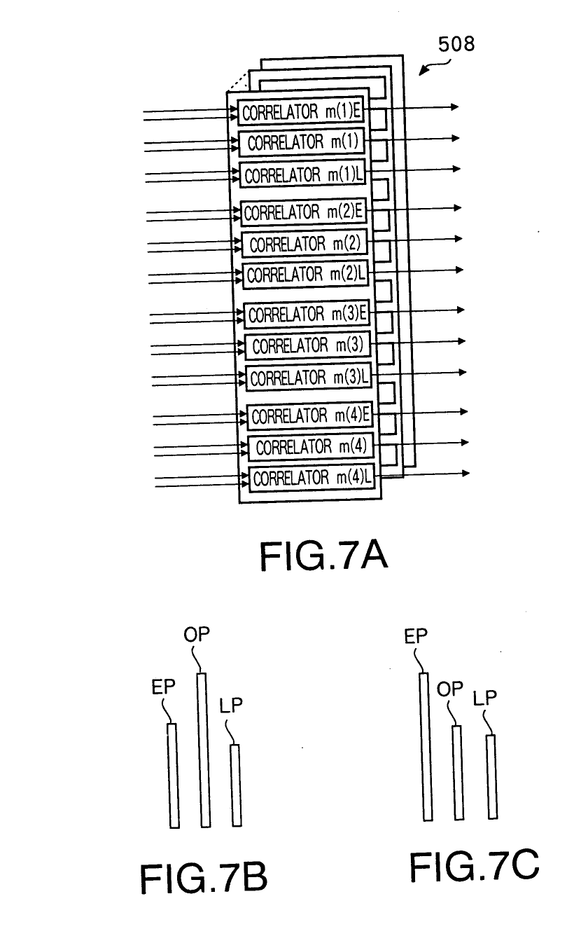

FIG. 7A is a block diagram illustrating a configuration of a correlation section 508 in a receiving apparatus according to Embodiment 3 of the present invention, and FIG. 7B and FIG. 7C are views each illustrating an example of a correlation value output.

In the present embodiment, the correlator 508 having a configuration that detects an early path, an on-time path and a late path as illustrated in FIG. 7A is used as the common midamble correlation section 408 of FIG. 6.

The correlator 508 of FIG. 7A includes correlators m(1)E, m(2)E, . . . , m(4)E that perform correlation operation at timing earlier than the relevant timing and correlators m(1)L, . . . , m(4)L that perform correlation operation at timing later than the relevant timing in addition to the correlators for on-time path detection.

An operation at this time will be explained using FIG. 7B and 7C.

FIG. 7B is a view illustrating an output of the correlator at a certain timing. At this time, when the path position varies due to time variation from the position of the path allocated by the detection of the path position based on the beacon channel, there occurs a case which is different from the path position at the time when demodulation processing is performed. At this time, correlation detection processing is executed to the paths before and after the relevant timing by the configuration of the correlator of FIG. 7A, thereby enabling to follow such a variation in path even when path arrival time becomes earlier as illustrated in FIG. 7C (at first, timing is one as illustrated in FIG. 7B and therefrom varies to timing as illustrated in FIG. 7C).

Therefore, according to the communication terminal apparatus of the present embodiment, accuracy in path estimation can be further improved.

As explained above, according to the present invention, even when the midamble shift of the common midamble to be transmitted changes according to the number of codes to be multiplexed, the window intervals subject to averaging are averaged and moved according to the midamble shift to detect the path position, thereby making it possible to suppress noise of the received signal and improve the accuracy of path position detection.

Moreover, before the correlation detection processing using the common midamble, correlation detection processing is executed using the fixed known code and averaging processing is executed at this stage, thereby enabling to reduce the danger of erroneous path detection and improve the accuracy of path position detection.

The present invention employs the known signal or uses different information obtained from the received signal effectively, and no special load is put on hardware and software, so that the implementation is simple.

Additionally, the functions of the CDMA receiving apparatus described in Embodiments 1 to 3 can be expressed as follows.

When a transmitting signal of a CDMA system, in which the shift amount of a common midamble changes according to the number of codes multiplexed, is received, and when delay profiles are generated to detect the position of a usable path, one or two or more delay profile generation processings are provided during the path position detection, averaging processing with correlation values obtained through correlation detection processing is surely executed at the stage of the first delay profile generation processing with the received signal. When the number of the delay profile generation processings is only one, the averaging processing is implemented by detecting the shift amount of the common midamble and by, based upon the detection result, adaptively determining the window interval where the averaging processing is executed. When the number of the delay profile generation processings is two or more, the first delay profile generation processing is executed using a fixed known code included in the received signal, thereby detecting the path position.

Moreover, when receiving a transmitting signal of CDMA system where the shift amount of a common midamble changes according to the number of codes multiplexed, and when delay profiles are generated to detect the position of a usable path, information on the phase shift amount is obtained from the delay profile obtained as a result of correlation detection with the common midamble, and the information on the phase shift amount is given to an averaging processing section. By this means, averaging processing is executed only in a window interval where averaging processing should be executed, thereby detecting the path position.

Furthermore, when receiving a transmitting signal of CDMA system in which the shift amount of a common midamble changes according to the number of codes multiplexed, and when delay profiles are generated to detect the position of a usable path, the series of processings for the detection of the path position is largely divided into two stages of preliminary correlation detection processing using a fixed known code, and correlation detection processing with the common midamble. Averaging processing with the delay profiles is executed at the stage of the preliminary correlation detection, thereby detecting the path position.

### Industrial Applicability

The present invention can be applied to a CDMA receiving apparatus installed in a mobile station apparatus and a base station apparatus in a mobile communication system.

1. A CDMA receiving apparatus comprising:
a midamble correlation section that detects a sliding correlation between a received signal and a basic midamble;
a delay profile generating section that generates a delay profile from a correlation value as a detection result of the sliding correlation;
an averaging section that averages the delay profile; and
a path detecting section that detect a path position of the received signal from the averaged delay profile.

2. A CDMA receiving apparatus comprising:
a midamble correlation section that detects a sliding correlation between a received signal of a midamble segment of a beacon channel and a basic midamble;
a delay profile generating section that generates a delay profile from a correlation value as a detection result of the sliding correlation;
an averaging section that averages the delay profile;
a path detecting section that detects a path position of the beacon channel from the averaged delay profile;
a correlation section that performs correlation operation with a received signal of a time slot of a path as a detecting object at timing of the detected path position;
a determination value calculating section that calculates a determination value from the correlation value output obtained by the correlation operation;
a midamble shift detecting section that detects a midamble shift amount from the determination value;
a selector that selects the correlation value output according to the midamble shift amount; and
a path determining section that determines a path position of the received signal from the correlation value output selected by said selector.

3. The CDMA receiving apparatus according to claim 2, wherein SYNC-DL, which is an initial synchronization code, is used in place of the midamble of the beacon channel.

4. The CDMA receiving apparatus according to claim 2, wherein said correlation section performs correlation operation with the received signal of time slots before and after the timing.

5. The CDMA receiving apparatus according to claim 2, wherein the determination value calculated by said determination value calculating section is one that is obtained by combining correlation values of paths of the respective midamble shifts.

6. The CDMA receiving apparatus according to claim 2, wherein the determination value calculated by said determination value calculating section is a maximum value of correlation values of paths of the respective midamble shifts.

7. A mobile communication terminal apparatus having the CDMA receiving apparatus described in claim 1.

8. A base station apparatus having the CDMA receiving apparatus described in claim 1.
